(19) United States
(12) Patent Application Publication
(10) Pub. No.: US 2023/0140310 A1
(43) Pub. Date: May 4, 2023

(54) Apparatus, Method, and Computer Program

(71) Applicant: Nokia Technologies Oy, Espoo (FI)

(72) Inventors: Jussi-Pekka KOSKINEN, Oulu (FI); Jorma Johannes KAIKKONEN, Oulu (FI); Samuli Heikki TURTINEN, Ii (FI)

(21) Appl. No.: 17/914,810

(22) PCT Filed: Apr. 3, 2020
(86) PCT No.: PCT/EP2020/059545

§ 371 Date: Sep. 27, 2022

(51) Int. Cl. H04W 74/08; H04L 5/00; H04W 48/08

(52) U.S. Cl. CPC H04W 74/0833; H04L 5/0053; H04W 48/08

(57) ABSTRACT

An apparatus including: at least one processor; and at least one memory including computer program code; the at least one memory and the computer program code configured to, with the at least one processor, cause the apparatus at least to: provide an indication of a preferred bandwidth part among a first bandwidth part and at least one second bandwidth part indicated by a base station or an indication of a bandwidth part capability of the apparatus to the base station.

### FIELD OF THE DISCLOSURE

The present disclosure relates to an apparatus, a method, and a computer program for providing and/or receiving an indication of a preferred bandwidth part or an indication of a bandwidth part capability to communicate between a terminal and a base station in a cellular system.

### BACKGROUND

A communication system can be seen as a facility that enables communication sessions between two or more entities such as user terminals, base stations/access points and/or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet. In a wireless communication system at least a part of a communication session between at least two stations occurs over a wireless link.

A user can access the communication system by means of an appropriate communication device or terminal. A communication device of a user is often referred to as user equipment (UE) or user device. A communication device is provided with an appropriate signal receiving and transmitting apparatus for enabling communications, for example enabling access to a communication network or communications directly with other users. The communication device may access a carrier provided by a station or access point, and transmit and/or receive communications on the carrier.

The communication system and associated devices typically operate in accordance with a required standard or specification which sets out what the various entities associated with the system are permitted to do and how that should be achieved. Communication protocols and/or parameters which shall be used for the connection are also typically defined. One example of a communications system is UTRAN (3G radio). Another example of an architecture that is known as the long-term evolution (LTE) or the Universal Mobile Telecommunications System (UMTS) radio-access technology. Another example communication system is so called 5G radio or new radio (NR) access technology.

### SUMMARY

According to an aspect there is provided an apparatus comprising at least one processor and at least one memory including computer code for one or more programs, the at least one memory and the computer code configured, with the at least one processor, to cause the apparatus at least to: provide an indication of a preferred bandwidth part among a first bandwidth part and at least one second bandwidth part indicated by a base station or an indication of a bandwidth part capability of the apparatus to the base station.

The at least one memory and the computer program code may be configured to, with the at least one processor, cause the apparatus at least to: determine a preferred bandwidth part among the first bandwidth part and the at least one second bandwidth part indicated by a base station.

The first bandwidth part may be indicated in a master information message and the at least one second bandwidth part may be indicated in a system information message.

The at least one memory and the computer program code may be configured to, with the at least one processor, cause the apparatus at least to: determine a bandwidth part capability of the apparatus; and determine the preferred bandwidth part among the first bandwidth part and the second bandwidth part indicated from the base station based on the bandwidth part capability of the apparatus.

The first bandwidth part may be a control resource set bandwidth part.

The at least one second bandwidth part may be an initial bandwidth part.

The at least one second bandwidth part may be wider than the first bandwidth part.

The at least one memory and the computer program code may be configured to, with the at least one processor, cause the apparatus at least to: provide the indication of the preferred bandwidth part to the base station in a message 1 of a random access channel procedure.

The at least one memory and the computer program code may be configured to, with the at least one processor, cause the apparatus at least to: provide the indication of the preferred bandwidth part to the base station based on a physical random access channel resource selected by the apparatus to send the message 1 of the random access channel procedure.

The at least one memory and the computer program code may be configured to, with the at least one processor, cause the apparatus at least to: provide the indication of the preferred bandwidth part to the base station in a message A or message 3 of a random access channel procedure.

The at least one memory and the computer program code may be configured to, with the at least one processor, cause the apparatus at least to: provide the indication of the preferred bandwidth part to the base station in a radio resource control message.

The radio resource control message may comprise a radio resource control setup request message, a radio resource control resume request message or a radio resource control reestablishment request message.

The at least one memory and the computer program code may be configured to, with the at least one processor, cause the apparatus at least to: provide the indication of the preferred bandwidth part to the base station based on a physical uplink shared channel uplink resource allocation in a message 2 of the random access channel procedure and a physical uplink shared channel resource selected by the apparatus to send the message 3 of the random access channel procedure.

The at least one memory and the computer program code may be configured to, with the at least one processor, cause the apparatus at least to: provide the indication of the preferred bandwidth part to the base station based on an uplink scheduling offset between a physical uplink shared channel resource allocation in a message 2 of the random access channel procedure and a physical uplink shared channel resource selection to send a message 3 of the random access channel procedure.

The at least one memory and the computer program code may be configured to, with the at least one processor, cause the apparatus at least to: provide the indication of the preferred bandwidth part to the base station based on a physical layer configuration selected by the apparatus to send the message A or the message 3 of the random access channel procedure.

The physical layer configuration selected by the apparatus may comprise a demodulation reference signal initialization, a demodulation reference signal location or a payload scrambling initialization.

The at least one memory and the computer program code may be configured to, with the at least one processor, cause the apparatus at least to: provide an indication of the preferred bandwidth part to the base station based on a physical uplink shared channel resource allocation in a message B of a random access channel procedure and a physical uplink shared channel resource selected by the apparatus to send a physical uplink shared channel transmission.

The at least one memory and the computer program code may be configured to, with the at least one processor, cause the apparatus at least to: provide the indication of the preferred bandwidth part to the base station based on an uplink scheduling offset between the physical uplink shared channel uplink grant in the message B of the random access channel procedure and the physical uplink shared channel resource selected by the apparatus to send the physical uplink shared channel transmission.

The at least one memory and the computer program code may be configured to, with the at least one processor, cause the apparatus at least to: provide the indication of the preferred bandwidth part to the base station in a radio resource control setup complete message, a radio resource control resume complete message or a radio resource control reestablishment complete message.

The at least one memory and the computer program code may be configured to, with the at least one processor, cause the apparatus at least to: provide the indication of the preferred bandwidth part to the base station in a medium access control control element or an uplink control information.

The at least one second bandwidth part may comprise a plurality of second bandwidth parts.

A number of the plurality of second bandwidth part is based on a maximum number of second bandwidth parts supported by the apparatus or a maximum number of second bandwidth parts requested by the apparatus.

The at least one memory and the computer program code are configured to, with the at least one processor, cause the apparatus at least to: provide an indication of a bandwidth part capability of the apparatus to the base station in a message 1, a message 3 or a message 5 of a random access channel procedure.

According to an aspect there is provided an apparatus comprising means for: providing an indication of a preferred bandwidth part among a first bandwidth part and at least one second bandwidth part indicated by a base station or an indication of a bandwidth part capability of the apparatus to the base station.

The apparatus may comprise means for: determining a preferred bandwidth part among the first bandwidth part and the at least one second bandwidth part indicated by a base station.

The first bandwidth part may be indicated in a master information message and the at least one second bandwidth part may be indicated in a system information message.

The apparatus may comprise means for: determining a bandwidth part capability of the apparatus; and determining the preferred bandwidth part among the first bandwidth part indicated and the second bandwidth part indicated from the base station based on the bandwidth part capability of the apparatus.

The first bandwidth part may be a control resource set bandwidth part.

The at least one second bandwidth part may be an initial bandwidth part.

The at least one second bandwidth part may be wider than the first bandwidth part.

The apparatus may comprise means for: providing the indication of the preferred bandwidth part to the base station in a message 1 of a random access channel procedure.

The apparatus may comprise means for: providing the indication of the preferred bandwidth part to the base station based on a physical random access channel resource selected by the apparatus to send the message 1 of the random access channel procedure.

The apparatus may comprise means for: providing the indication of the preferred bandwidth part to the base station in a message A or message 3 of a random access channel procedure.

The apparatus may comprise means for: providing the indication of the preferred bandwidth part to the base station in a radio resource control message.

The radio resource control message may comprise a radio resource control setup request message, a radio resource control resume request message or a radio resource control reestablishment request message.

The apparatus may comprise means for: providing the indication of the preferred bandwidth part to the base station based on a physical uplink shared channel uplink resource allocation in a message 2 of the random access channel procedure and a physical uplink shared channel resource selected by the apparatus to send the message 3 of the random access channel procedure.

The apparatus may comprise means for: providing the indication of the preferred bandwidth part to the base station based on an uplink scheduling offset between a physical uplink shared channel resource allocation in a message 2 of the random access channel procedure and a physical uplink shared channel resource selection to send a message 3 of the random access channel procedure.

The apparatus may comprise means for: providing the indication of the preferred bandwidth part to the base station based on a physical layer configuration selected by the apparatus to send the message A or the message 3 of the random access channel procedure.

The physical layer configuration selected by the apparatus may comprise a demodulation reference signal initialization, a demodulation reference signal location or a payload scrambling initialization.

The apparatus may comprise means for: providing an indication of the preferred bandwidth part to the base station based on a physical uplink shared channel resource allocation in a message B of a random access channel procedure and a physical uplink shared channel resource selected by the apparatus to send a physical uplink shared channel transmission.

The apparatus may comprise means for: providing the indication of the preferred bandwidth part to the base station based on an uplink scheduling offset between the physical uplink shared channel uplink grant in the message B of the random access channel procedure and the physical uplink shared channel resource selected by the apparatus to send the physical uplink shared channel transmission.

The apparatus may comprise means for: providing the indication of the preferred bandwidth part to the base station in a radio resource control setup complete message, a radio resource control resume complete message or a radio resource control reestablishment complete message.

The apparatus may comprise means for: providing the indication of the preferred bandwidth part to the base station in a medium access control control element or an uplink control information.

The at least one second bandwidth part may comprise a plurality of second bandwidth parts.

A number of the plurality of second bandwidth part is based on a maximum number of second bandwidth parts supported by the apparatus or a maximum number of second bandwidth parts requested by the apparatus.

The apparatus may comprise means for: providing an indication of a bandwidth part capability of the apparatus to the base station in a message 1, a message 3 or a message 5 of a random access channel procedure.

According to an aspect there is provided an apparatus comprising circuitry configured to: provide an indication of a preferred bandwidth part among a first bandwidth part and at least one second bandwidth part indicated by a base station or an indication of a bandwidth part capability of the apparatus to the base station.

The apparatus may comprise circuitry configured to: determine a preferred bandwidth part among the first bandwidth part and the at least one second bandwidth part indicated by a base station.

The first bandwidth part may be indicated in a master information message and the at least one second bandwidth part may be indicated in a system information message.

The apparatus may comprise circuitry configured to: determine a bandwidth part capability of the apparatus; and determine the preferred bandwidth part among the first bandwidth part indicated and the second bandwidth part indicated from the base station based on the bandwidth part capability of the apparatus.

The first bandwidth part may be a control resource set bandwidth part.

The at least one second bandwidth part may be an initial bandwidth part.

The at least one second bandwidth part may be wider than the first bandwidth part.

The apparatus may comprise circuitry configured to: provide the indication of the preferred bandwidth part to the base station in a message 1 of a random access channel procedure.

The apparatus may comprise circuitry configured to: provide the indication of the preferred bandwidth part to the base station based on a physical random access channel resource selected by the apparatus to send the message 1 of the random access channel procedure.

The apparatus may comprise circuitry configured to: provide the indication of the preferred bandwidth part to the base station in a message A or message 3 of a random access channel procedure.

The apparatus may comprise circuitry configured to: provide the indication of the preferred bandwidth part to the base station in a radio resource control message.

The radio resource control message may comprise a radio resource control setup request message, a radio resource control resume request message or a radio resource control reestablishment request message.

The apparatus may comprise circuitry configured to: provide the indication of the preferred bandwidth part to the base station based on a physical uplink shared channel uplink resource allocation in a message 2 of the random access channel procedure and a physical uplink shared channel resource selected by the apparatus to send the message 3 of the random access channel procedure.

The apparatus may comprise circuitry configured to: provide the indication of the preferred bandwidth part to the base station based on an uplink scheduling offset between a physical uplink shared channel resource allocation in a message 2 of the random access channel procedure and a physical uplink shared channel resource selection to send a message 3 of the random access channel procedure.

The apparatus may comprise circuitry configured to: provide the indication of the preferred bandwidth part to the base station based on a physical layer configuration selected by the apparatus to send the message A or the message 3 of the random access channel procedure.

The physical layer configuration selected by the apparatus may comprise a demodulation reference signal initialization, a demodulation reference signal location or a payload scrambling initialization.

The apparatus may comprise circuitry configured to: provide an indication of the preferred bandwidth part to the base station based on a physical uplink shared channel resource allocation in a message B of a random access channel procedure and a physical uplink shared channel resource selected by the apparatus to send a physical uplink shared channel transmission.

The apparatus may comprise circuitry configured to: provide the indication of the preferred bandwidth part to the base station based on an uplink scheduling offset between the physical uplink shared channel uplink grant in the message B of the random access channel procedure and the physical uplink shared channel resource selected by the apparatus to send the physical uplink shared channel transmission.

The apparatus may comprise circuitry configured to: provide the indication of the preferred bandwidth part to the base station in a radio resource control setup complete message, a radio resource control resume complete message or a radio resource control reestablishment complete message.

The apparatus may comprise circuitry configured to: provide the indication of the preferred bandwidth part to the base station in a medium access control control element or an uplink control information.

The at least one second bandwidth part may comprise a plurality of second bandwidth parts.

A number of the plurality of second bandwidth part is based on a maximum number of second bandwidth parts supported by the apparatus or a maximum number of second bandwidth parts requested by the apparatus.

The apparatus may comprise circuity configured to: provide an indication of a bandwidth part capability of the apparatus to the base station in a message 1, a message 3 or a message 5 of a random access channel procedure.

According to an aspect there is provided a method comprising: provide an indication of a preferred bandwidth part among a first bandwidth part and at least one second bandwidth part indicated by a base station or an indication of a bandwidth part capability of the apparatus to the base station.

The method may comprise: determining a preferred bandwidth part among the first bandwidth part and the at least one second bandwidth part indicated by a base station.

The first bandwidth part may be indicated in a master information message and the at least one second bandwidth part may be indicated in a system information message.

The method may comprise: determining a bandwidth part capability of the apparatus; and determining the preferred bandwidth part among the first bandwidth part indicated and the second bandwidth part indicated from the base station based on the bandwidth part capability of the apparatus.

The first bandwidth part may be a control resource set bandwidth part.

The at least one second bandwidth part may be an initial bandwidth part.

The at least one second bandwidth part may be wider than the first bandwidth part.

The method may comprise: providing the indication of the preferred bandwidth part to the base station in a message 1 of a random access channel procedure.

The method may comprise: providing the indication of the preferred bandwidth part to the base station based on a physical random access channel resource selected by the apparatus to send the message 1 of the random access channel procedure.

The method may comprise: providing the indication of the preferred bandwidth part to the base station in a message A or message 3 of a random access channel procedure.

The method may comprise: providing the indication of the preferred bandwidth part to the base station in a radio resource control message.

The radio resource control message may comprise a radio resource control setup request message, a radio resource control resume request message or a radio resource control reestablishment request message.

The method may comprise: providing the indication of the preferred bandwidth part to the base station based on a physical uplink shared channel uplink resource allocation in a message 2 of the random access channel procedure and a physical uplink shared channel resource selected by the apparatus to send the message 3 of the random access channel procedure.

The method may comprise: providing the indication of the preferred bandwidth part to the base station based on an uplink scheduling offset between a physical uplink shared channel resource allocation in a message 2 of the random access channel procedure and a physical uplink shared channel resource selection to send a message 3 of the random access channel procedure.

The method may comprise: providing the indication of the preferred bandwidth part to the base station based on a physical layer configuration selected by the apparatus to send the message A or the message 3 of the random access channel procedure.

The physical layer configuration selected by the apparatus may comprise a demodulation reference signal initialization, a demodulation reference signal location or a payload scrambling initialization.

The method may comprise: providing an indication of the preferred bandwidth part to the base station based on a physical uplink shared channel resource allocation in a message B of a random access channel procedure and a physical uplink shared channel resource selected by the apparatus to send a physical uplink shared channel transmission.

The method may comprise: providing the indication of the preferred bandwidth part to the base station based on an uplink scheduling offset between the physical uplink shared channel uplink grant in the message B of the random access channel procedure and the physical uplink shared channel resource selected by the apparatus to send the physical uplink shared channel transmission.

The method may comprise: providing the indication of the preferred bandwidth part to the base station in a radio resource control setup complete message, a radio resource control resume complete message or a radio resource control reestablishment complete message.

The method may comprise: providing the indication of the preferred bandwidth part to the base station in a medium access control control element or an uplink control information.

The at least one second bandwidth part may comprise a plurality of second bandwidth parts.

A number of the plurality of second bandwidth part is based on a maximum number of second bandwidth parts supported by the apparatus or a maximum number of second bandwidth parts requested by the apparatus.

The method may comprise: providing an indication of a bandwidth part capability of the apparatus to the base station in a message 1, a message 3 or a message 5 of a random access channel procedure.

According to an aspect there is provided a computer program comprising computer executable code which when run on at least one processor is configured to: provide an indication of a preferred bandwidth part among a first bandwidth part and at least one second bandwidth part indicated by a base station or an indication of a bandwidth part capability of the apparatus to the base station.

The computer program may comprise computer executable code which when run on at least one processor is configured to: determine a preferred bandwidth part among the first bandwidth part and the at least one second bandwidth part indicated by a base station.

The first bandwidth part may be indicated in a master information message and the at least one second bandwidth part may be indicated in a system information message.

The computer program may comprise computer executable code which when run on at least one processor is configured to: determine a bandwidth part capability of the apparatus; and determine the preferred bandwidth part among the first bandwidth part indicated and the second bandwidth part indicated from the base station based on the bandwidth part capability of the apparatus.

The first bandwidth part may be a control resource set bandwidth part.

The at least one second bandwidth part may be an initial bandwidth part.

The at least one second bandwidth part may be wider than the first bandwidth part.

The computer program may comprise computer executable code which when run on at least one processor is configured to: provide the indication of the preferred bandwidth part to the base station in a message 1 of a random access channel procedure.

The computer program may comprise computer executable code which when run on at least one processor is configured to: provide the indication of the preferred bandwidth part to the base station based on a physical random access channel resource selected by the apparatus to send the message 1 of the random access channel procedure.

The computer program may comprise computer executable code which when run on at least one processor is configured to: provide the indication of the preferred bandwidth part to the base station in a message A or message 3 of a random access channel procedure.

The computer program may comprise computer executable code which when run on at least one processor is configured to: provide the indication of the preferred bandwidth part to the base station in a radio resource control message.

The radio resource control message may comprise a radio resource control setup request message, a radio resource control resume request message or a radio resource control reestablishment request message.

The computer program may comprise computer executable code which when run on at least one processor is configured to: provide the indication of the preferred bandwidth part to the base station based on a physical uplink shared channel uplink resource allocation in a message 2 of the random access channel procedure and a physical uplink shared channel resource selected by the apparatus to send the message 3 of the random access channel procedure.

The computer program may comprise computer executable code which when run on at least one processor is configured to: provide the indication of the preferred bandwidth part to the base station based on an uplink scheduling offset between a physical uplink shared channel resource allocation in a message 2 of the random access channel procedure and a physical uplink shared channel resource selection to send a message 3 of the random access channel procedure.

The computer program may comprise computer executable code which when run on at least one processor is configured to: provide the indication of the preferred bandwidth part to the base station based on a physical layer configuration selected by the apparatus to send the message A or the message 3 of the random access channel procedure.

The physical layer configuration selected by the apparatus may comprise a demodulation reference signal initialization, a demodulation reference signal location or a payload scrambling initialization.

The computer program may comprise computer executable code which when run on at least one processor is configured to: provide an indication of the preferred bandwidth part to the base station based on a physical uplink shared channel resource allocation in a message B of a random access channel procedure and a physical uplink shared channel resource selected by the apparatus to send a physical uplink shared channel transmission.

The computer program may comprise computer executable code which when run on at least one processor is configured to: provide the indication of the preferred bandwidth part to the base station based on an uplink scheduling offset between the physical uplink shared channel uplink grant in the message B of the random access channel procedure and the physical uplink shared channel resource selected by the apparatus to send the physical uplink shared channel transmission.

The computer program may comprise computer executable code which when run on at least one processor is configured to: provide the indication of the preferred bandwidth part to the base station in a radio resource control setup complete message, a radio resource control resume complete message or a radio resource control reestablishment complete message.

The computer program may comprise computer executable code which when run on at least one processor is configured to: provide the indication of the preferred bandwidth part to the base station in a medium access control control element or an uplink control information.

The at least one second bandwidth part may comprise a plurality of second bandwidth parts.

A number of the plurality of second bandwidth part is based on a maximum number of second bandwidth parts supported by the apparatus or a maximum number of second bandwidth parts requested by the apparatus.

The computer program may comprise computer executable code which when run on at least one processor is configured to: provide an indication of a bandwidth part capability of the apparatus to the base station in a message 1, a message 3 or a message 5 of a random access channel procedure.

According to an aspect there is provided an apparatus comprising at least one processor and at least one memory including computer code for one or more programs, the at least one memory and the computer code configured, with the at least one processor, to cause the apparatus at least to: receive an indication of a preferred bandwidth part among a first bandwidth part and at least one second bandwidth part indicated by the apparatus to the terminal or an indication of a bandwidth part capability of the apparatus to the base station from a terminal.

According to an aspect there is provided an apparatus comprising means for: receiving an indication of a preferred bandwidth part among a first bandwidth part and at least one second bandwidth part indicated by the apparatus to the terminal or an indication of a bandwidth part capability of the apparatus to the base station from a terminal.

According to an aspect there is provided an apparatus comprising circuitry configured to: receive an indication of a preferred bandwidth part among a first bandwidth part and at least one second bandwidth part indicated by the apparatus to the terminal or an indication of a bandwidth part capability of the apparatus to the base station from a terminal.

According to an aspect there is provided a method comprising: receiving an indication of a preferred bandwidth part among a first bandwidth part and at least one second bandwidth part indicated by the apparatus to the terminal or an indication of a bandwidth part capability of the apparatus to the base station from a terminal.

According to an aspect there is provided a computer program comprising computer executable code which when run on at least one processor is configured to receive an indication of a preferred bandwidth part among a first bandwidth part and at least one second bandwidth part indicated by the apparatus to the terminal or an indication of a bandwidth part capability of the apparatus to the base station from a terminal.

According to an aspect, there is provided a computer readable medium comprising program instructions stored thereon for performing at least one of the above methods.

According to an aspect, there is provided a non-transitory computer readable medium comprising program instructions stored thereon for performing at least one of the above methods.

According to an aspect, there is provided a non-volatile tangible memory medium comprising program instructions stored thereon for performing at least one of the above methods.

In the above, many different aspects have been described. It should be appreciated that further aspects may be provided by the combination of any two or more of the aspects described above.

Various other aspects are also described in the following detailed description and in the attached claims.

### List of Abbreviations

AF: Application Function
AMF: Access Management Function
AUSF: Authentication Server Function
BS: Base Station
BW: Bandwidth
BWP: Bandwidth Part
CORESET: Control Resource Set
CE: Control Element
CU: Centralized Unit
DCI: Downlink Control Information
DL: Downlink
DM-RS: Demodulation Reference Signal
DN: Data Network
DU: Distributed Unit
eNB: enhanced NodeB
eMBB: enhanced Mobile Broadband
eURLLC: enhanced Ultra Reliable and Low Latency Communication
FDD: Frequency Division Duplex
FR: Frequency Range
gNB: gNodeB
GSM: Global System for Mobile communication
HSS: Home Subscriber Server
IE: Information Element
IMT: International Mobile Communication
IoT: Internet of Things
IWSN: Industrial Wireless Sensor Network
LPWA: Low Power Wide Area
LTE: Long Term Evolution
LTE-M: Long Term Evolution Machine type communication
MAC: Medium Access Control
MIB: Master Information Block
MS: Mobile Station
MSG: message
MTC: Machine Type Communication
mMTC: massive Machine Type Communication
NEF: Network Exposure Function
NR: New radio
PDCCH: Physical Downlink Shared Channel
PDU: Packet Data Unit
PRACH: Physical Random Access Channel
PUSCH: Physical Uplink Shared Channel
PRB: Physical Resource Block
RACH: Random Access Channel
RAM: Random Access Memory
RAN: Radio Access Network
REDCAP: Reduced Capability
REL: Release
RF: Radio Frequency
ROM: Read Only Memory
RRC: Radio Resource Control
RX: Reception
SCS: Subcarrier Spacing
SIB: System Information Block
SID: Study Item Description
SMF: Session Management Function
SSB: Synchronisation Signal Block
TR: Technical Report
TS: Technical Specification
TSC: Time Sensitive Communication
TSN: Time Sensitive Network
TX: Transmission
UCI: Uplink Control information
UDM: User Data Management
UE: User Equipment
UL: Uplink
UMTS: Universal Mobile Telecommunication System
URLLC: Ultra Reliable and Low Latency Communication
USB: Universal
WI: Work Item
3GPP: 3^{rd} Generation Partnership Project
5G: 5^{th} Generation
5GCN: 5G Core network
5GRAN: 5G Radio Access Network
5GS: 5G System

### BRIEF DESCRIPTION OF THE FIGURES

Embodiments will now be described, by way of example only, with reference to the accompanying Figures in which:

FIG. 1 shows a schematic representation of a 5G system;

FIG. 2 shows a schematic representation of a control apparatus;

FIG. 3 shows a schematic representation of a terminal;

FIG. 4 shows a schematic representation of signalling diagram of a process for providing and/or receiving an indication of a preferred bandwidth part to communicate between a terminal and a base station in a cellular system;

FIG. 5 shows another schematic representation of signalling diagram of a method performed by a terminal for providing an indication of a preferred bandwidth part to communicate with a base station in a cellular system;

FIG. 6 shows another schematic representation of signalling diagram of a method performed by a base station for receiving an indication of a preferred bandwidth part to communicate with a terminal in a cellular system; and

FIG. 7 shows a schematic representation of a non-volatile memory medium storing instructions which when executed by a processor allow a processor to perform one or more of the steps of the methods of FIGS. 5 and 6.

### DETAILED DESCRIPTION OF THE FIGURES

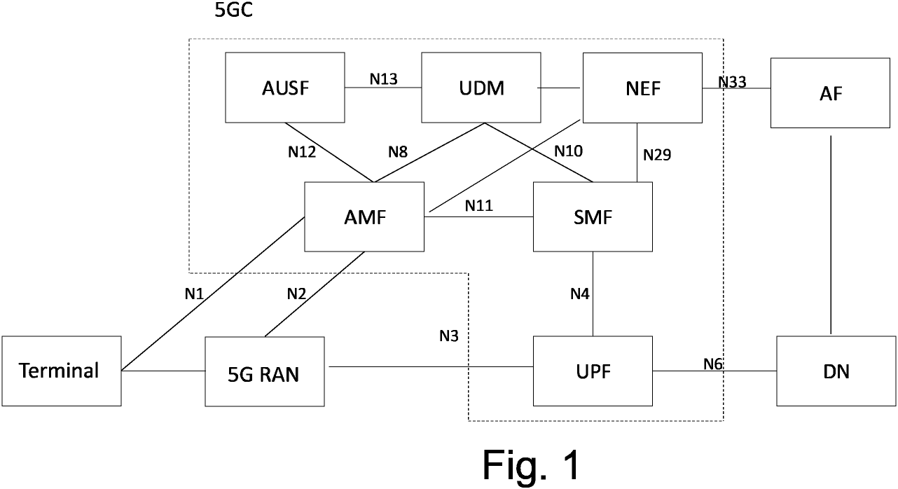

In the following certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS). The 5GS may comprises a terminal, a 5G radio access network (5GRAN), a 5G core network (5GCN), one or more application function (AF) and one or more data networks (DN).

The 5GRAN may comprise one or more gNodeB (GNB) distributed unit functions connected to one or more gNodeB (GNB) centralized unit functions.

The 5GCN may comprise an access management function (AMF), a session management function (SMF), an authentication server function (AUSF), a user data management (UDM), a user plane function (UPF) and/or a network exposure function (NEF).

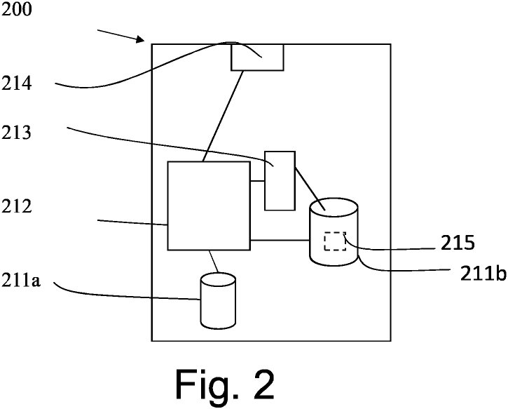

FIG. 2 illustrates an example of a control apparatus 200 for controlling a function of the 5GRAN or the 5GCN as illustrated on FIG. 1. The control apparatus may comprise at least one random access memory (RAM) 211 a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5GRAN or the 5GCN. In some embodiments, each function of the 5GRAN or the 5GCN comprises a control apparatus 200. In alternative embodiments, two or more functions of the 5GRAN or the 5GCN may share a control apparatus.

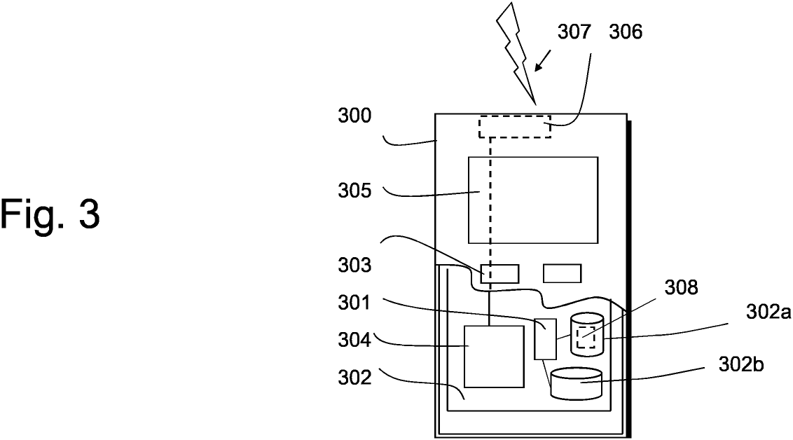

FIG. 3 illustrates an example of a terminal 300, such as the terminal illustrated on FIG. 1. The terminal 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, a Cellular Internet of things (CIoT) device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302a and the ROM 211b. The at least one processor 301 may be configured to execute an appropriate software code 308. The software code 308 may for example allow to perform one or more of the present aspects. The software code 308 may be stored in the ROM 302b.

The processor, storage and other relevant control apparatus can be provided on an appropriate circuit board and/or in chipsets. This feature is denoted by reference 304. The device may optionally have a user interface such as keypad 305, touch sensitive screen or pad, combinations thereof or the like. Optionally one or more of a display, a speaker and a microphone may be provided depending on the type of the device.

One or more aspects of this disclosure relate to supporting NR devices with reduced capability (redcap).

One or more aspects of this disclosure relate to reference “New SID on Support of Reduced Capability NR Devices” (RP-193238).

Section “3 Justification” of reference “New SID on Support of Reduced Capability NR Devices” (RP-193238) reads:

“The usage scenarios that have been identified for 5G are enhanced mobile broadband (eMBB), massive machine-type communication (mMTC), and Ultra-Reliable and Low Latency communication (URLLC). Yet another identified area to locate the boundary between mMTC and URLLC would be time sensitive communication (TSC). In particular, mMTC, URLLC and TSC are associated with novel IoT use cases that are targeted in vertical industries. It is envisaged that eMBB, mMTC, URLLC and TSC use cases may all need to be supported in the same network. In the 3GPP study on “self-evaluation towards IMT-2020 submission” it was confirmed that NB-IoT and LTE-M fulfill the IMT-2020 requirements for mMTC and can be certified as 5G technologies. For URLLC support, URLLC features were introduced in Release 15 for both LTE and NR, and NR URLLC is further enhanced in Release 16 within the enhanced URLLC (eURLLC) and Industrial IoT work items. Rel-16 also introduced support for Time-Sensitive Networking (TSN) and 5G integration for TSC use cases.

One important objective of 5G is to enable connected industries. 5G connectivity can serve as catalyst for next wave of industrial transformation and digitalization, which improve flexibility, enhance productivity and efficiency, reduce maintenance cost, and improve operational safety. Devices in such environment include e.g. pressure sensors, humidity sensors, thermometers, motion sensors, accelerometers, actuators, etc. It is desirable to connect these sensors and actuators to 5G networks and core. The massive industrial wireless sensor network (IWSN) use cases and requirements described in TR 22.804, TS 22.104, TR 22.832 and TS 22.261 include not only URLLC services with very high requirements, but also relatively low-end services with the requirement of small device form factors, and/or being completely wireless with a battery life of several years. The requirements for these services that are higher than LPWA (i.e. LTE-M/NB-IOT) but lower than URLCC and eMBB.

Similar to connected industries, 5G connectivity can serve as catalyst for the next wave smart city innovations. As an example, TS 22.804 describes smart city use case and requirements for that. The smart city vertical covers data collection and processing to more efficiently monitor and control city resources, and to provide services to city residents. Especially, the deployment of surveillance cameras is an essential part of the smart city but also of factories and industries.

Finally, wearables use case includes smart watches, rings, eHealth related devices, and medical monitoring devices etc. One characteristic for the use case is that the device is small in size.

As a baseline, the requirements for these three use cases are:
Generic requirements:
   Device complexity: Main motivation for the new device type is to lower the device cost and complexity as compared to high-end eMBB and URLLC devices of Rel-15/Rel-16. This is especially the case for industrial sensors.
   Device size: Requirement for most use cases is that the standard enables a device design with compact form factor.
   Deployment scenarios: System should support all FR1/FR2 bands for FDD and TDD.
Use case specific requirements:
   Industrial wireless sensors: Reference use cases and requirements are described in TR 22.832 and TS 22.104: Communication service availability is 99.99% and end-to-end latency less than 100 ms. The reference bit rate is less than 2 Mbps (potentially asymmetric e.g. UL heavy traffic) for all use cases and the device is stationary. The battery should last at least few years. For safety related sensors, latency requirement is lower, 5-10 ms (TR 22.804) Video Surveillance: As described in TS 22.804, reference economic video bitrate would be 2-4 Mbps, latency < 500 ms, reliability 99%-99.9%. High-end video e.g. for farming would require 7.5-25 Mbps. It is noted that traffic pattern is dominated by UL transmissions. Wearables: Reference bitrate for smart wearable application can be 10-50 Mbps in DL and minimum 5 Mbps in UL and peak bit rate of the device higher, 150 Mbps for downlink and 50 Mbps for uplink. Battery of the device should last multiple days (up to 1-2 weeks).

The intention is to study a UE feature and parameter list with lower end capabilities, relative to Release 16 eMBB and URLLC NR to serve the three use cases mentioned above”.

Section “4.1 of “SI or Core part WI or Testing part WI” of reference “New SID on Support of Reduced Capability NR Devices” (RP-193238) reads:

“The study item includes the following objectives:

Identify and study potential UE complexity reduction features, including [RANI, RAN2]:
Reduced number of UE RX/TX antennas
UE Bandwidth reduction
Note: Rel-15 SSB bandwidth should be reused and L1 changes minimized
Half-Duplex-FDD
Relaxed UE processing time
Relaxed UE processing capability”

As can be seen, the reduced capability NR devices may be able to utilize the SSB bandwidth defined in Rel-15 and in general the L1 changes may be minimized. Hence, it may be assumed that a control resource set (CORESET) #0 bandwidth part (BWP) may be able to be used by the REDCAP NR devices.

A CORESET #0 BWP may be used to schedule and transmit some or all of the system information messages, paging, and/or DL transmissions in response to a random access channel (RACH) procedure. The RACH procedure may be used to perform initial access.

A CORESET #0 BW may be configured by master information block (MIB) and may be selected among {24,48,96} physical resource blocks (PRBs) to support different system/carrier bandwidth deployments.

An initial DL bandwidth part (BWP) may be configured in a system information block 1 (SIB1). The initial DL BWP may be up to a system BW. The initial DL BWP may be assumed to be used by a NR device after a reception of a Msg4 (e.g. RRCSetup message, RRCReestablishment message or RRCResume message) of a RACH procedure. The network may identify whether the NR device is a REDCAP NR device before sending the Msg4 of the RACH procedure so that any scheduling commands over a physical downlink control channel (PDCCH) sent by the network after this time point may be sent on the initial DL BWP. The initial DL BWP may restrict the bandwidth of a physical downlink shared channel (PDSCH) for broadcast and it may be desirable to allocate it as wide as possible.

More specifically, in SIB1 a NR device is provided with a SCS carrier configuration comprising an initial UL BWP and an initial DL BWP that the NR device needs to support to be able to access a cell.

Section “5.2.2.4.2 Actions upon reception of the SIB1” of TS 38. 331 reads:
“<Omitted text>
2> if the UE supports one or more of the frequency bands indicated in the frequencyBandList for downlink for TDD, or one or more of the frequency bands indicated in the frequencyBandList for uplink for FDD, and they are not downlink only bands, and
2> if the UE supports at least one additionalSpectrumEmission in the NR-NS-PmaxList for a supported band in the downlink for TDD, or a supported band in uplink for FDD, and
2> if the UE supports an uplink channel bandwidth with a maximum transmission bandwidth configuration (see TS 38.101-1 [15] and TS 38.101-2 [39]) which
   is smaller than or equal to the carrierbandwidth (indicated in uplinkConfigCommon for the SCS of the initial uplink BVVP), and which
   is wider than or equal to the bandwidth of the initial uplink BVVP, and
2> if the UE supports a downlink channel bandwidth with a maximum transmission bandwidth configuration (see TS 38.101-1 [15] and TS 38.101-2 [39]) which
   is smaller than or equal to the carrierBandwidth (indicated in downlinkConfigCommon for the SCS of the initial downlink BVVP), and which
   is wider than or equal to the bandwidth of the initial downlink BWP:
3> apply a supported uplink channel bandwidth with a maximum transmission bandwidth which
   is contained within the carrierBandwidth indicated in uplinkConfigCommon for the SCS of the initial uplink BVVP, and which
   is wider than or equal to the bandwidth of the initial BWP for the uplink;
3> apply a supported downlink channel bandwidth with a maximum transmission bandwidth which
   is contained within the carrierBandwidth indicated in downlinkConfigCommon for the SCS of the initial downlink BVVP, and which
   is wider than or equal to the bandwidth of the initial B WP for the downlink;
<Omitted text>
2> else:
3> consider the cell as barred in accordance with TS 38.304 [20]; and
3> perform barring as if intraFreqReselection is set to notAllowed;”
A NR device may be provided in SIB1 with a SCS carrier configuration comprising an initial UL BWP and an initial DL BWP (e.g. given by locationAndBandwidth fields in uplinkConfigCommon and downlinkConfigCommon respectively). The initial UL BWP and the initial DL BWP may take effect after Msg4 transmissions as described in Section 5.3.3.4.

The initial UL BWP and the initial DL BWP may be considered separately as a condition for barring access to a cell. The initial UL BWP and an initial DL BWP need to fall within a SCS carrier configuration of a NR device. Such BWP specific condition has been removed (see R2-1915488).

The restricted capabilities of a REDCAP NR device may require the network to adjust the initial UL BWP and an initial DL BWP in a manner that is sub-optimal for a normal capability NR device. The parameters locationAndBandwidth fields and carrierBandwidth fields in uplinkConfigCommon and downlinkConfigCommon would need to be set so that the REDCAP NR device limitations are met.

A solution would be for a REDCAP NR device to ignore the carrierBandwidth fields in uplinkConfigCommon and downlinkConfigCommon when considering the access to a cell. That is, a REDCAP NR device may ignore the need for the carrierBandwidth fields to be less or equal than the capability of the REDCAP NR device. This would somewhat reduce a network deployment limitation. This would enable a REDCAP NR device to access a cell assuming that communication is continued based on a CORESET#0 BWP provided in MIB until the BWP capability of the REDCAP NR device is exchanged with the network (e.g. Msg5 and beyond).

Alternatively, a new barring behaviour based on the initial UL BWP and the initial DL BWP provided in SIB1 could be considered (similar to the one that was removed by R2-1915488). However, ignoring the initial UL BWP and the initial DL BWP provided in SIB1 may create a problem that the network would not be able to know what BWP the network may use to communicate with r a REDCAP NR device after Msg4 (before the BWP capability of the REDCAP NR device is provided to the network).

To prevent the barring/blocking/ambiguity of a REDCAP NR device based on the initial UL BWP and the initial DL BWP provided in SIB1, the initial UL BWP and the initial DL BWP provided in SIB1 may be set narrow by the network so that it may be supported by both a normal capability NR device and a REDCAP NR device. In practice this would mean that the initial UL BWP and the initial DL BWP provided in SIB1 may be the same as the CORESET #0 BWP, thus making the initial UL BWP and the initial DL BWP redundant and reducing the initial data rates for eMBB NR devices.

In summary, REDCAP NR devices, such as MTC NR devices, may be allowed to camp on a cell if a BW reduced version of the system information is scheduled on the cell. In REDCAP NR devices work item an objective is to minimize changes especially related to physical layer and therefore it may be desirable not to define new system information messages and scheduling for REDCAP NR devices.

One or more aspects of this disclosure provide a mechanism that allows a network to know from early steps of initial access what is the BWP preference/limitation/capability of a NR device.

A NR device may determine a preferred BWP among a CORESET#0 BWP provided in a MIB or an initial BWP provided in the SIB1 from a network. The preferred BWP may be based on the BWP capability of the NR device (i.e. whether the NR device is a normal capability NR device or a REDCAP NR device). The CORESET#0 BWP may comprise a DL CORESET#0 BWP and/or an UL CORESET#0 BWP. The initial BWP may comprise a DL initial BWP and/or an UL initial BWP. The preferred BWP may comprise a preferred DL BWP and/or a preferred UL BWP. The NR device may indicate the preferred BWP to the network via UL signalling.

The indication of the preferred BWP may be provided by the NR device based on a physical random access channel (PRACH) resource selection. Certain PRACH resources may be reserved for indicating that the preferred BWP is the CORESET#0 BWP provided in the MIB and/or other PRACH resources may be reserved for indicating that the preferred BWP is the initial BWP provided in the SIB1.

The indication of the preferred BWP may be provided by the NR device based on a RACH preamble selection. Certain RACH preambles may be reserved for indicating that the preferred BWP UE is the CORESET#0 BWP provided in the MIB and/or other PRACH resources may be reserved for indicating that the preferred BWP is the initial BWP provided in the SIB1.

The indication of the preferred BWP may be provided by the NR device in a MsgA or a Msg3 of a RACH procedure.

The indication of the preferred BWP may be provided by the NR device based on a PUSCH resource selection. A random access response (e.g. in a Msg2 or MsgB of a RACH procedure) from the network may provide two (or more) alternative PUSCH resource allocations (e.g. in medium access control (MAC) packet data unit (PDU) for random access response) from which the NR device can select based on the preferred BWP.

In one example an UL scheduling slot offset (e.g. k2) may be changed by the NR device based on the preferred BW. That is, for indicating that the preferred BWP is the initial BWP provided in the SIB1 the scheduling slot offset (e.g. k2) may be used whereas for indicating that the preferred BWP is the CORESET#0 BWP provided in the MIB a different scheduling slot offset may be used, or vice versa. The different scheduling slot offset may be the scheduling slot offset (e.g. k2) with an offset. The scheduling slot offset (e.g. k2) and/or the offset to the scheduling slot offset (e.g. k2) may be provided in DCI. The scheduling slot offset (e.g. k2) and/or the offset to the scheduling slot offset (e.g. k2) may be in a MAC PDU or broadcast.

The indication of the preferred BWP may be provided by the NR device based a physical layer configuration of PUSCH.. For example, a demodulation reference signal (DM-RS) initialization or location could be adjusted based on the preferred BWP. Additionally or alternatively, a scrambling initialization of a payload could be done based on the preferred BWP. PUSCH may carry a MsgA or a Msg3 of a RACH procedure.

The indication of the preferred BWP may be provided by the NR device in a radio resource control (RRC) message.

The indication of the preferred BWP may be provided by the NR device in an RRC message (e.g. RRCSetupRequest message, RRCResumeRequest message or RRCReestablishmentRequest) in a Msg 3 of a RACH procedure. The indication maybe provided as an addition establishment cause or additional information element (IE).

The indication of the preferred BWP may be provided by the NR device in a RRC message (e.g. RRCSetupComplete message, RRCResumeComplete message or RRCReestablishmentComplete message) in a Msg 5 of a RACH procedure.

The indication of the preferred BWP may be provided by the NR device in a MAC control element (CE).

The indication of the preferred BWP may be provided by the NR device in a physical layer message, for example in uplink control information (UCI).

The network may provide more than on BWP in SIB1 (e.g. BWP1, BWP2 and BWP3) among which the NR device may determine the preferred BWP. A number of BWPs provided in SIB1 may be based on a maximum number of BWPs supported by the NR device or a maximum number of BWPs requested by the NR device. The maximum number of BWPs supported by the NR device or a maximum number of BWPs requested by the NR device may be based on a criterion (e.g. UL buffer).

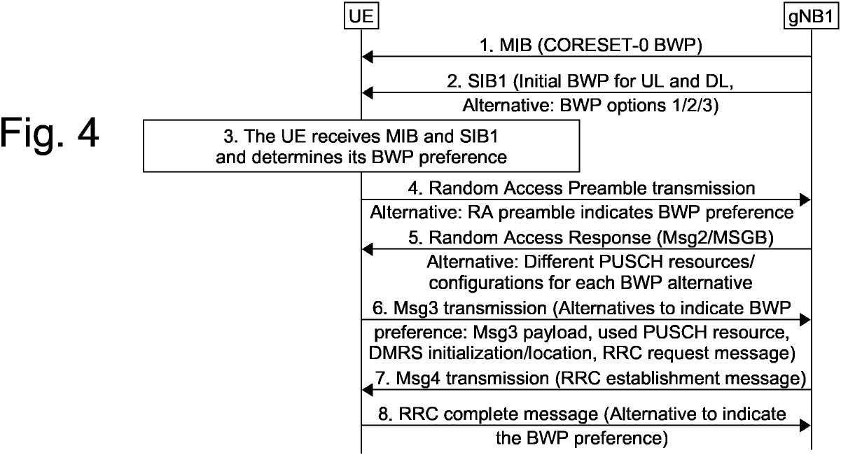

FIG. 4 shows a schematic representation of signalling diagram of a process for providing and/or receiving an indication of a preferred BWP to communicate between a NR device and the network in a cellular system.

In step 1, a NR device (UE) may receive a MIB message from the network (gNB). The MIB message may provide a CORESET#0 BWP. The CORESET#0 BWP may comprise an UL CORESET#0 BWP and/or a DL CORESET#0 BWP.

In step 2, the NR device may receive a SIB1 message from the network. The SIB1 message may provide an initial BWP. The initial BWP may comprise an UL initial BWP and/or a DL initial BWP. Alternatively, the SIB1 message may provide an initial BWP1, an initial BWP2 and an initial BWP3. The initial BWP1 may comprise an UL initial BWP1 and/or a DL initial BWP1. The initial BWP2 may comprise an UL initial BWP2 and/or a DL initial BWP2. The initial BWP3 may comprise an UL initial BWP3 and/or a DL initial BWP3.

The NR device may determine a preferred BWP based on the CORESET#0 BWP and the initial BWP. Alternatively, the NR device may determine a preferred BWP based on the CORESET#0 BWP, the initial BWP1, the initial BWP2 and the initial BWP3. The preferred BWP may be based on a BWP capability of the NR device (i.e. whether the NR device is a normal capability NR device or a REDCAP NR device).

The NR device may initiate access to the network. The NR may initiate a RACH procedure with the network. The RACH procedure may be a four-step RACH procedure comprising Msg1, Msg2, Msg3 and Msg4 or a two-step RACH procedure comprising MsgA and MsgB.

In step 4, the NR device may send a Msg 1 or MsgA to the network. The NR device may send a RACH preamble to the network on a PRACH resource.

The NR device may provide an indication of the preferred BWP based on the RACH preamble selected. One or more RACH preambles may be associated with the CORESET#0 BWP whereas one or more RACH preambles may be associated with the initial BWP. Alternatively, one or more RACH preambles may be associated with the CORESET#0 BWP whereas one or more other RACH preambles may be associated with the initial BWP1, one or more other RACH preambles may be associated with the initial BWP2 and one or more other RACH preambles may be associated with the initial BWP3.

The NR device may provide an indication of the preferred BWP based on the PRACH resource selected. One or more PRACH resources may be associated with the CORESET#0 BWP whereas one or more PRACH resources may be associated with the initial BWP. Alternatively, one or more PRACH resources may be associated with the CORESET#0 BWP whereas one or more other PRACH resources may be associated with the initial BWP1, one or more other PRACH resources may be associated with the initial BWP2 and one or more other PRACH resources may be associated with the initial BWP3.

The NR device may provide an indication of the preferred BWP based on the MsgA resource selected. One or more PRACH resources and/or RACH preambles and/or PUSCH resources of MsgA may be associated with the CORESET#0 BWP whereas one or more of PRACH resources and/or RACH preambles and/or PUSCH resources of MsgA may be associated with the initial BWP. Alternatively, one or more PRACH resources and/or RACH preambles and/or PUSCH resources of MsgA may be associated with the CORESET#0 BWP whereas one or more other PRACH resources and/or RACH preambles and/or PUSCH resources of MsgA may be associated with the initial BWP1, one or more other PRACH resources and/or RACH preambles and/or PUSCH resources of MsgA may be associated with the initial BWP2 and one or more other PRACH resources and/or RACH preambles and/or PUSCH resources of MsgA may be associated with the initial BWP3.

In step 5, the NR device may receive a Msg2 or MsgB from the network. The NR device may receive one or more PUSCH resource allocations. One or more PUSCH resource allocations may be associated with the CORESET#0 BWP whereas one or more PUSCH resource allocations may be associated with the initial BWP. Alternatively, one or more PUSCH resource allocations may be associated with the CORESET#0 BWP whereas one or more other PUSCH resource allocations may be associated with the initial BWP1, one or more other PUSCH resource allocations may be associated with the initial BWP2 and one or more other PUSCH resource allocations may be associated with the initial BWP3.

In step 6, the NR device may send a Msg3 to the network. The NR device may send an RRC message to the network (e.g. an RRC establishment message). The NR device may provide an indication of the preferred BWP in a payload of the Msg3. The NR device may provide an indication of the preferred BWP based on the PUSCH resource allocation selected to send the Msg3. The NR device may provide an indication of the preferred BWP based on a physical layer configuration of the PUSCH (e.g. based on DM-RS initialization and/or location). The NR device may provide an indication of the preferred BWP in the RRC message (e.g. an RRC request message).

In step 7, the NR device may receive a Msg4 from the network. The NR device may receive an RRC message from the network (e.g. an RRC establishment message).

In step 8, the NR device may send a Msg5 to the network. The NR device may send an RRC message to the network (e.g. an RRC complete message). The NR device may provide an indication of the preferred BWP in the RRC message (e.g. an RRC complete message).

The NR device and the network may then use the preferred BWP to communicate on the UL and/or the DL.

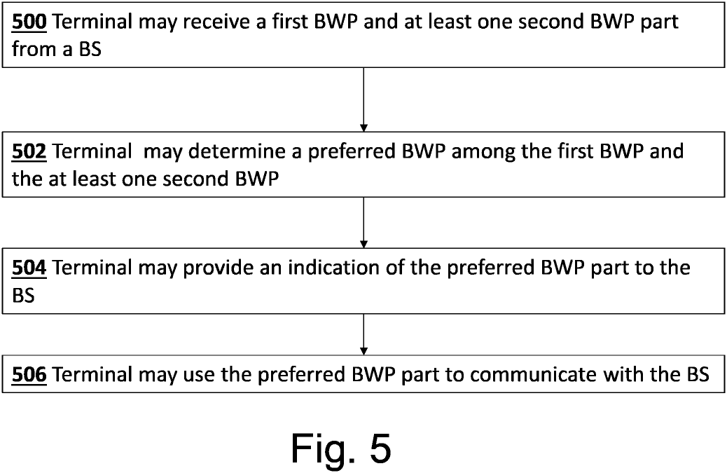

FIG. 5 shows another schematic representation of signalling diagram of a method performed by a terminal (e.g. NR device) for providing an indication of a preferred BWP to communicate with a BS (e.g. gNB) in a cellular system (e.g. 5GS).

In step 500, the terminal may receive an indication of a first BWP and at least one second BWP part from a BS.

The first BWP may be indicated in a master information message (e.g. MIB). The at least one second BWP part may be indicated in a system information message (e.g. SIB1).

The first BWP may be a control resource set BWP (e.g. CORESET #0 BWP). The at least one second BWP may be an initial BWP.

The at least one second BWP may be wider than the first BWP.

The at least one second BWP may comprise a plurality of second bandwidth parts. Number of the plurality of second BWPs may be based on a maximum number of second BWPs supported by the terminal or a maximum number of second BWPs requested by the terminal.

In step 502, the terminal may determine a preferred BWP among the first BWP and the at least one second BWP indicated by the BS.

The terminal may determine a BWP capability of the terminal (e.g. whether the terminal is a normal BWP capability terminal or a reduce BWP capability terminal. The terminal may then determine the preferred BWP among the first BWP indicated in the master information message and the second BWP indicated in the system information message from the BS based on the BWP capability of the terminal.

In step 504, the terminal may provide an indication of the preferred BWP to the BS.

The terminal may provide the indication of the preferred BWP to the BS in a message 1 of a RACH procedure.

The terminal may provide the indication of the preferred BWP to the BS based on a PRACH resource selected by the terminal to send the message 1 of the RACH procedure.

The terminal may provide the indication of the preferred BWP part to the BS in a message A (MsgA) or message 3 of a RACH procedure. The terminal may provide an indication of the preferred BWP to the BS in an RRC message. The RRC message may comprise a RRC setup request message, a RRC resume request message or a RRC reestablishment request message.

The terminal may provide the indication of the preferred BWP to the BS based on a PUSCH resource allocation in a message 2 of a RACH procedure and a PUSCH resource selected by the terminal to send a message 3 of the RACH procedure.

The terminal may provide the indication of the preferred BWP to the BS based on an UL scheduling offset (e.g. k2) between a PUSCH resource allocation in a message 2 of a RACH procedure and a PUSCH resource selected by the terminal to send a message 3 of the RACH procedure.

The terminal may provide the indication of the preferred BWP to the BS based on a physical layer configuration selected by the terminal to send a message A or a message 3 of a RACH procedure. The physical layer configuration selected by the terminal may comprise a DM-RS initialization, a DM-RS location or a payload scrambling initialization.

The terminal may provide the indication of the preferred BWP to the BS based on a PUSCH resource allocation in a message B of a RACH procedure and a PUSCH resource selected by the terminal to send a PUSCH transmission.

The terminal may provide the indication of the preferred BWP to the BS based on an uplink scheduling offset (e.g. k2) between the PUSCH resource allocation in the message B of the RACH procedure and the PUSCH resource selected by the terminal to send the PUSCH transmission.

The terminal may provide the indication of the preferred BWP to the BS in a RRC setup complete message, a RRC resume complete message or a RRC reestablishment complete message.

The terminal may provide the indication of the preferred BWP to the BS in a MAC CE or a UCI.

In step 506, the terminal may use the preferred BWP to communicate with the BS.

Alternatively, the terminal may provide an indication of the BWP capability of the terminal (i.e. whether the terminal has reduced BWP capability or normal BWP capability) to the BS so that the BS may directly determine the preferred BWP among the first BWP and the at least one second BWP. The terminal may provide the indication of a BWP capability of the terminal to the BS in a message 1 a message 3 or a message 5 of a RACH procedure.

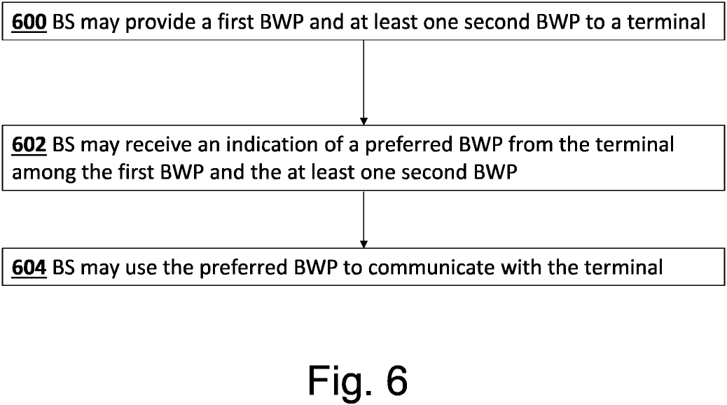

FIG. 6 shows another schematic representation of signalling diagram of a method performed by BS (e.g. gNB) for receiving an indication of a preferred BWP part to communicate with a terminal (e.g. NR device) in a cellular system (e.g. 5GS).

In step 600, the BS may provide an indication of a first BWP and at least one second BWP part to the terminal.

The first BWP may be indicated in a master information message (e.g. MIB). The at least one second BWP part may be indicated in a system information message (e.g. SIB1).

The first BWP may be a control resource set BWP (e.g. CORESET #0 BWP). The at least one second BWP may be an initial BWP.

The at least one second BWP may be wider than the first BWP.

The at least one second BWP may comprise a plurality of second bandwidth parts. Number of the plurality of second BWPs may be based on a maximum number of second BWPs supported by the terminal or a maximum number of second BWPs requested by the terminal.

In step 602, the BS may receive an indication of a preferred BWP from the terminal among the first BWP and the at least one second BWP.

The BS may receive the indication of the preferred BWP from the terminal in a message 1 of a RACH procedure.

The BS may receive the indication of the preferred BWP from the terminal based on a PRACH resource selected by the terminal to send the message 1 of the RACH procedure.

The BS may receive the indication of the preferred BWP from the terminal in a message A or a message 3 of a RACH procedure. The terminal may provide an indication of the preferred BWP to the BS in an RRC message. The RRC message may comprise a RRC setup request message, a RRC resume request message or a RRC reestablishment request message.

The BS may receive the indication of the preferred BWP from the terminal based on a PUSCH resource allocation in a message 2 of a RACH procedure and a PUSCH resource selected by the terminal to send a message 3 of the RACH procedure.

The BS may receive the indication of the preferred BWP from the terminal based on an UL scheduling offset (e.g. k2) between a PUSCH resource allocation in a message 2 of a RACH procedure and a PUSCH resource selected by the terminal to send a message 3 of the RACH procedure.

The BS may receive the indication of the preferred BWP from the terminal based on a physical layer configuration selected by the terminal to send a message A or a message 3 of a RACH procedure. The physical layer configuration selected by the terminal may comprise a DM-RS initialization, a DM-RS location or a payload scrambling initialization.

The BS may receive the indication of the preferred BWP from the terminal based on a PUSCH resource allocation in a message B of a RACH procedure and a PUSCH resource selected by the terminal to send a PUSCH transmission.

The BS may receive the indication of the preferred BWP from the terminal based on an uplink scheduling offset (e.g. k2) between the PUSCH resource allocation in the message B of the RACH procedure and the PUSCH resource selected by the terminal to send the PUSCH transmission.

The BS may receive the indication of the preferred BWP from the terminal in a RRC setup complete message, a RRC resume complete message or a RRC reestablishment complete message.

The terminal may provide the indication of the preferred BWP to the BS in a MAC CE or a UCI.

In step 604, the BS may use the preferred BWP to communicate with the terminal.

Alternatively, the BS may receive an indication of the BWP capability of the terminal (i.e. whether the terminal has reduced BWP capability or normal BWP capability) from the terminal so that the BS may directly determine the preferred BWP among the first BWP and the at least one second BWP. The terminal may provide the indication of the BWP capability of the terminal to the BS in a message 1 a message 3 or a message 5 of a RACH procedure.

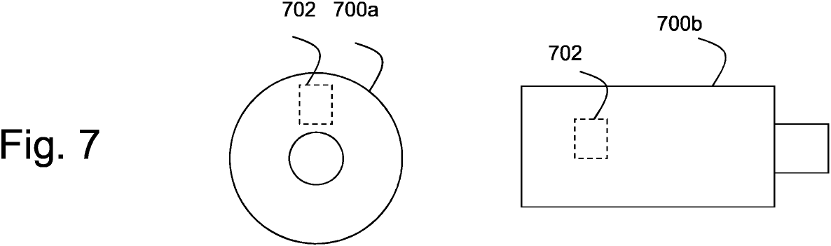

FIG. 7 shows a schematic representation of non-volatile memory media 700a (e.g. computer disc (CD) or digital versatile disc (DVD)) and 700b (e.g. universal serial bus (USB) memory stick) storing instructions and/or parameters 702 which when executed by a processor allow the processor to perform one or more of the steps of the methods of FIGS. 5 or 6.

It is noted that while the above describes example embodiments, there are several variations and modifications which may be made to the disclosed solution without departing from the scope of the present invention.

It will be understood that although the above concepts have been discussed in the context of a 5GS, one or more of these concepts may be applied to other cellular systems.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any procedures, e.g., as in FIGS. 5 or 6, may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Alternatively or additionally some embodiments may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments. However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1. An apparatus comprising:
at least one processor; and
at least one non-transitory memory including computer program code;
the at least one memory and the computer program code configured to, with the at least one processor, cause the apparatus at least to:
provide an indication of a preferred bandwidth part among a first bandwidth part and at least one second bandwidth part indicated by a base station or an indication of a bandwidth part capability of the apparatus to the base station.

2. The apparatus of claim 1, wherein the at least one memory and the computer program code are configured to, with the at least one processor, cause the apparatus at least to determine a preferred bandwidth part among the first bandwidth part and the at least one second bandwidth part indicated by a base station.

3. The apparatus of claim 2, wherein the first bandwidth part is indicated in a master information message and the at least one second bandwidth part is indicated in a system information message.

4. The apparatus of claim 2, wherein the at least one memory and the computer program code are configured to, with the at least one processor, cause the apparatus at least to:
determine a bandwidth part capability of the apparatus; and
determine the preferred bandwidth part among the first bandwidth part indicated and the second bandwidth part indicated from the base station based on the bandwidth part capability of the apparatus.

5. The apparatus of claim 1, wherein the first bandwidth part is a control resource set bandwidth part.

6. The apparatus of claim 1, wherein the at least one second bandwidth part is an initial bandwidth part.

7. The apparatus of claim 1, wherein the at least one second bandwidth part is wider than the first bandwidth part.

8. The apparatus of claim 1, wherein the at least one memory and the computer program code are configured to, with the at least one processor, cause the apparatus at least to:
provide the indication of the preferred bandwidth part to the base station in a message 1 of a random access channel procedure.

9. The apparatus of claim 8, wherein the at least one memory and the computer program code are configured to, with the at least one processor, cause the apparatus at least to:
provide the indication of the preferred bandwidth part to the base station based on a physical random access channel resource selected by the apparatus to send the message 1 of the random access channel procedure.

10. The apparatus of claim 1, wherein the at least one memory and the computer program code are configured to, with the at least one processor, cause the apparatus at least to: provide the indication of the preferred bandwidth part to the base station in a message A or message 3 of a random access channel procedure.

11. The apparatus of claim 10, wherein the at least one memory and the computer program code are configured to, with the at least one processor, cause the apparatus at least to:
provide the indication of the preferred bandwidth part to the base station in a radio resource control message.

12. The apparatus of claim 11, wherein the radio resource control message comprises a radio resource control setup request message, a radio resource control resume request message or a radio resource control reestablishment request message.

13. The apparatus of claim 10, wherein the at least one memory and the computer program code are configured to, with the at least one processor, cause the apparatus at least to:
provide the indication of the preferred bandwidth part to the base station based on a physical uplink shared channel uplink resource allocation in a message 2 of the random access channel procedure and a physical uplink shared channel resource selected by the apparatus to send the message 3 of the random access channel procedure.

14. The apparatus of claim 10, wherein the at least one memory and the computer program code are configured to, with the at least one processor, cause the apparatus at least to:
provide the indication of the preferred bandwidth part to the base station based on an uplink scheduling offset between a physical uplink shared channel resource allocation in a message 2 of the random access channel procedure and a physical uplink shared channel resource selection to send a message 3 of the random access channel procedure.

15. The apparatus of claim 10, wherein the at least one memory and the computer program code are configured to, with the at least one processor, cause the apparatus at least to:
provide the indication of the preferred bandwidth part to the base station based on a physical layer configuration selected by the apparatus to send the message A or the message 3 of the random access channel procedure.

16. The apparatus of claim 15, wherein the physical layer configuration selected by the apparatus comprises a demodulation reference signal initialization, a demodulation reference signal location or a payload scrambling initialization.

17. The apparatus of claim 1, wherein the at least one memory and the computer program code are configured to, with the at least one processor, cause the apparatus at least to:
provide an indication of the preferred bandwidth part to the base station based on a physical uplink shared channel resource allocation in a message B of a random access channel procedure and a physical uplink shared channel resource selected by the apparatus to send a physical uplink shared channel transmission.

18. The apparatus of claim 17, wherein the at least one memory and the computer program code are configured to, with the at least one processor, cause the apparatus at least to:
provide the indication of the preferred bandwidth part to the base station based on an uplink scheduling offset between the physical uplink shared channel uplink grant in the message B of the random access channel procedure and the physical uplink shared channel resource selected by the apparatus to send the physical uplink shared channel transmission.

19-23. (canceled)

24. An apparatus comprising:
at least one processor; and
at least one non-transitory memory including computer program code;
the at least one memory and the computer program code configured to, with the at least one processor, cause the apparatus at least to:
receive an indication of a preferred bandwidth part among a first bandwidth part and at least one second bandwidth part indicated by the apparatus to the terminal or an indication of a bandwidth part capability of the apparatus to the base station from a terminal.

25. A method comprising:
provide an indication of a preferred bandwidth part among a first bandwidth part and at least one second bandwidth part indicated by a base station or an indication of a bandwidth part capability of the apparatus to the base station.

26-27. (canceled)
